(19) United States
(12) Patent Application Publication
(10) Pub. No.: US 2009/0164343 A1
(43) Pub. Date: Jun. 25, 2009

(54) AUTO-CASCADING CLEAR TO BUILD ENGINE FOR MULTIPLE LOCATION ORDER LEVEL PARTS MANAGEMENT

(75) Inventors: George M. Hurtis, Rochester, MN (US); Jason S. Lee, Oronoco, MN (US); Kay M. Momsen, Rochester, MN (US); Ryan T. Paske, Rochester, MN (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: International Business Machines Corporation, Armonk, NY (US)

(21) Appl. No.: 11/961,584

(22) Filed: Dec. 20, 2007

(51) Int. Cl. G06Q 10/00

(52) U.S. Cl. 705/28

(57) ABSTRACT

Embodiments of the present invention provide a method, system and computer program product for multiple-location auto-cascading clear to build inventory management. In an embodiment of the invention, an order processing method can be provided. The order processing method can include determining a required allocation of parts necessary to build an order, recursively soft allocating parts in different locations until enough parts have been soft allocated to satisfy the required allocation of parts necessary to build the order, and hard allocating the soft allocated parts. In one aspect of the embodiment, it can be determined that not enough parts remain amongst the different locations to satisfy the required allocation of parts necessary to build the order. In that circumstance, the soft allocated parts can be cleared for allocation by a different order. Alternatively, the order can be built short by hard allocating the soft allocated parts even though not enough parts are soft allocated to satisfy the required allocation of parts.

### BACKGROUND OF THE INVENTION

1. Field of the Invention

The present invention relates to supply chain management and more particularly to an inventory management system utilizing clear to build inventory analysis.

2. Description of the Related Art

As the global economy provides a proliferation of options for businesses to expand into emerging markets, manufacturing success is increasingly defined by how fast you act and how well you react to supply chain volatility. Modern production facilities are increasingly becoming more complex as customers expect manufacturers to keep prices low while readily accommodating last-minute changes in quantity, product configuration or delivery date.

Effectively managing the timing, order policy, and supply and inventory considerations involved in new product introductions or upgrades, greatly impact cycle times, potential business opportunities, and most importantly sales and profits. Typical operations manufacture multiple products in numerous discrete areas called stocking locations within a single facility. Moreover, the parts needed to manufacture a specific product may be utilized and stocked in multiple discrete areas throughout a facility due to their common usage across various sub-assemblies and end products. Component parts may be stocked in warehouses, at sub-assembly lines, in multiple final build lines or in any number of other internal plant locations.

One problem that arises in such complex facilities is whether all the components necessary to build a specific product are available to support the build. After part coverage is determined, a secondary obstacle is determining what stock, from which inventory stocking areas needs to be utilized to complete the build in question. A common method in the art by which inventory is analyzed to determine whether an order can be built is often called “Clear to Build inventory analysis” (CTB).

Essentially, CTB is a process by which the component Bill of Material (BOM) needed to manufacture the product in question is compared against available inventory stocked in a facility. Although, the parts necessary to build a product can be stocked in multiple stocking locations, conventional CTB analysis can only operate upon one discrete inventory stocking location at a time. A discrete inventory stocking location can either be defined globally or locally.

When global CTB is performed an operation can quickly ascertain if it possesses the total number of parts necessary to support an order in a whole facility. However, performing global CTB does not efficiently allow determining which parts from which stocking location need to be aggregated to support the build in question. For instance, if Order X needed 2 quantities of Part A and 1 quantity of Part B, global CTB would be able to determine that there is an aggregate total of 17 Part A and 8 Part B in the whole facility without taking into account stocking locations. Thus, performing global CTB does not efficiently allow determination of which parts from which area need to be aggregated to support Order X in question. Moreover, as manual actions are taken to decide which parts from the various stocking locations need to be moved and allocated to a specific build, subsequent CTB analysis may be driving other manual activities that will be competing for the same parts.

Local CTB analysis allows determination of the ability to support a specific build with parts from one stocking location within a facility. However, when part shortages are determined in one specific area, additional manual actions are required to search other stocking locations for parts coverage. This could include additional separate CTB analyses in those other areas. Once again, these local CTB analyses often result in numerous manual activities to identify, isolate and move parts from one area to facilitate a build. For instance, if Order Y needed 2 quantities of Part A and 2 quantities of Part B, CTB inventory analysis would only be able to determine that there is zero quantities of Part A, and 4 quantities of Part B in stocking location S, 2 quantities of the 4 which satisfy the required amount for Part B. However, since Part A is not found in stocking location S, Order Y cannot be released. In order to find available quantities of Part A additional manual actions can be required to search other stocking locations for parts coverage.

Conventional CTB analysis lacks an efficient reservation mechanism. Merely searching each location at a time can cause the possibility that another order may ‘snatch’ a part that was previously contemplated by another order looking in another location. Also, with conventional CTB processes there is a chance that inventory may be ‘locked up’ in multiple orders that can only be partially completed instead of being able to fulfill the highest priority orders that can actually be completed. Thus, there are manual activities associated with typical CTB processes and the inherent difficulties in parts logistical management, especially in periods of extreme volatility and stress in a supply chain.

### BRIEF SUMMARY OF THE INVENTION

Embodiments of the present invention address deficiencies of the art in respect to order production management and provide a novel and non-obvious method, system and computer program product for multiple-location auto-cascading clear to build inventory management. In an embodiment of the invention, an order processing method can be provided. The order processing method can include determining a required allocation of parts necessary to build an order, recursively soft allocating parts in different locations until enough parts have been soft allocated to satisfy the required allocation of parts necessary to build the order, and hard allocating the soft allocated parts. In one aspect of the embodiment, it can be determined that not enough parts remain amongst the different locations to satisfy the required allocation of parts necessary to build the order. In that circumstance, the soft allocated parts can be cleared for allocation b to a different order. Alternatively, the order can be built short by hard allocating the soft allocated parts even though not enough parts are soft allocated to satisfy the required allocation of parts.

In another embodiment of the invention, an inventory management data processing system can be provided. The system can include a data store of parts and stocking locations storing the parts and a multiple location auto-cascading clear to build engine coupled to the data store. The engine can include program code enabled to determine a required allocation of parts necessary to build an order, to recursively soft allocate parts in different locations specified by the data store until enough parts have been soft allocated to satisfy the required allocation of parts necessary to build the order, and to hard allocate the soft allocated parts.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is schematic illustration of a CTB inventory management system utilizing a multiple-location auto-cascading CTB engine;

FIG. 2 is a flowchart illustrating a process for multi-location auto-cascading CTB analysis;

FIG. 3A is a block diagram illustrating inventory management rules incorporated into the multiple-location auto-cascading CTB analysis of FIG. 2;

FIG. 3B is a block diagram illustrating inventory location priority rules incorporated into the multiple-location auto-cascading CTB analysis of FIG. 2;

FIG. 3C is a block diagram illustrating location movement and offset times incorporated into the multiple-location auto-cascading CTB analysis of FIG. 2;

FIG. 4 is a flowchart illustrating a recursive process utilized by the multi-location auto-cascading CTB engine of FIG. 1; and,

FIG. 5 is a flowchart illustrating a process for aggregate kitting and inventory movements handled in the process of FIG. 2.

### DETAILED DESCRIPTION OF THE INVENTION

Embodiments of the present invention provide a method, system and computer program product for a multiple-location auto-cascading clear to build inventory management process. In one embodiment of the invention, the parts necessary to build a product is recursively located by a Multiple Location Auto-Cascading CTB engine incorporating inventory location priority information. The engine identifies specific stocking locations based on a prioritized list of possible locations for a part number and analyzes each stocking location to determine whether there is matching inventory in that current location. When the required amount for a part is found in a specific stocking location, the engine can permanently reserve those parts and move those parts to a proper location for assembly.

When the required amount can be partially satisfied at that location then the engine can temporarily reserve those parts and analyze the next stocking location listed by priority until all the parts necessary to fulfill a specific order has been satisfied. Subsequently, once all required parts have been located, the engine can be enabled to permanently reserve each part found in multiple locations. The required parts can be ready for inventory movement or kitting initiation and eventually built and shipped to a customer. By automating the manual processes required by conventional CTB analysis, the multiple-location auto-cascading CTB engine can allow inventory analysis recursively with new location priority rules and materials logistics management performed across a facility.

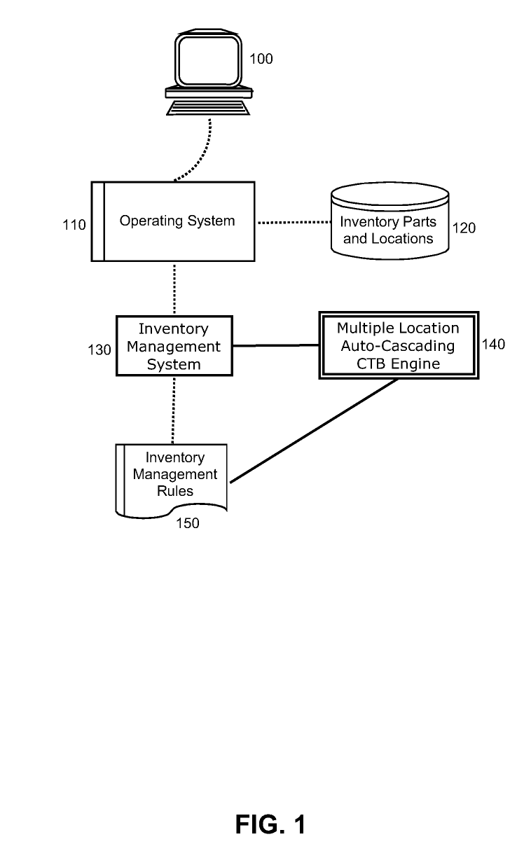

In further illustration, FIG. 1 is a schematic illustration of a CTB inventory management system utilizing a multiple-location auto-cascading CTB engine. A computer 100 with an operating system 110 can be coupled to a database 120 of inventory management data including inventory part numbers and stocking locations. An inventory management system 130 can be coupled to a multiple-location auto-cascading CTB engine 140. The inventory management rules 150 can be coupled to the inventory management system 130 and the multiple-location auto-cascading CTB engine 140. The inventory management rules 150 can enable the inventory management system 130 or the multiple-location auto-cascading CTB engine 140 to incorporate a priority list of stocking locations based on a specific part number or product.

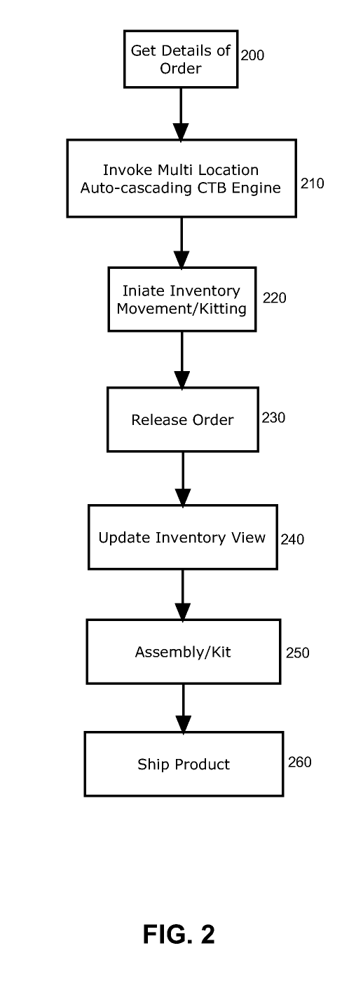

In further illustration, FIG. 2 is a flowchart of a multiple-location CTB analysis process. In block 200, the details of a customer order including a list of all parts required for the order, part numbers, and a list of locations sorted by highest priority can be retrieved. The multi-location auto-cascading CTB engine 210 can be invoked using a recursive soft allocation method to temporarily reserve available parts for an order in multiple stocking locations. In block 220 kitting and inventory movement can be initiated and in block 230 the order can be released. Finally, in block 240, the allocations and inventory can be updated and in block 250 the order can be assembled and eventually shipped to the customer in block 260.

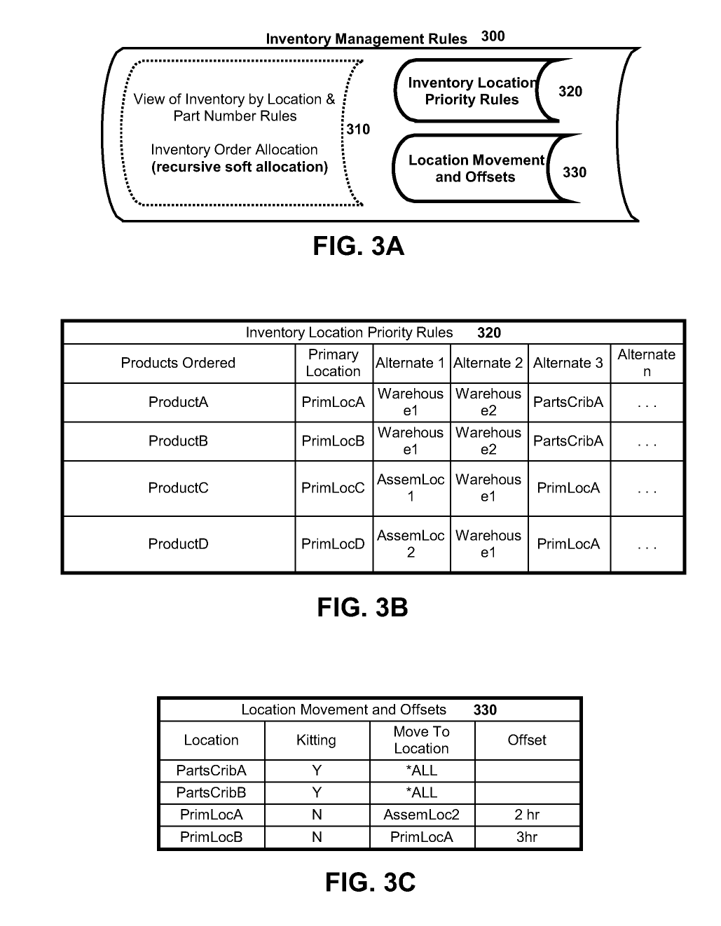

FIG. 3A is a block diagram illustrating inventory management rules incorporated into the multiple-location auto-cascading CTB analysis of FIG. 2. Block 310 of FIG. 3A contains the typical elements of a logistics system in enterprise resource planning for inventory management with the exception that the inventory order allocation method is done recursively in this analysis. Block 320 in turn shows a set of inventory location priority rules. The inventory location priority rules 320 can be based on each product. Each product can be assigned to its own primary location where the necessary parts to build that product are located or pulled for assembly execution.

In further illustration, FIG. 3B is a block diagram illustrating inventory location priority rules incorporated into the multiple-location auto-cascading CTB analysis of FIG. 2. For instance, when an order is selected for CTB analysis and the detailed list of parts and quantities required to build the order are exploded by the ERP system, the inventory location priority rules 320 determine the recursive path to be taken for that order based upon the specific product. When an order for ProductA is retrieved, the detailed parts of the order are exploded by the ERP system, then the multi-location auto-cascading CTB engine can be initiated to recursively check each stocking location, starting with the primary stocking location, PrimLocA.

By reference to the inventory location priority rules 320, if all the parts necessary to build ProductA cannot be located in PrimLocA then the multi-location auto-cascading CTB engine will soft-allocate each part found in that location and in each subsequent location that is recursively searched until all the demand is satisfied for the order to be built. If all required parts are not found once all locations are queried, then a decision can be made to release the order for build with short-parts depending on user preference or remove the soft allocations and return the order for ProductA back into the production queue. Finally, FIG. 3C is a block diagram illustrating the location movement and offset times incorporated into the inventor management rules 300 of FIG. 3A. Specifically, the location movement and offsets 330 provide for an offset time required for moving parts from one stocking location to another stocking location.

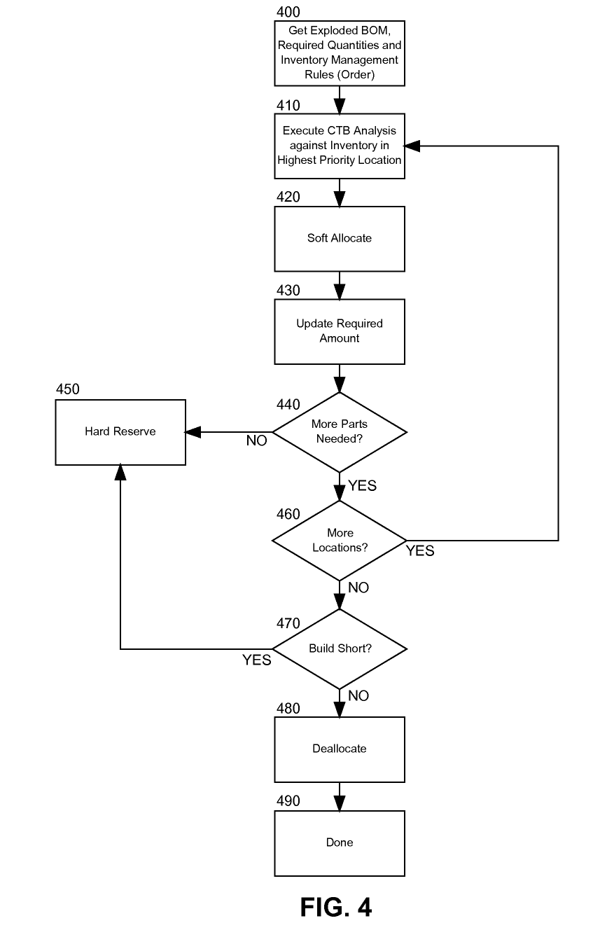

FIG. 4 is a flowchart illustrating the recursive process utilized by the multi-location auto-cascading CTB engine of FIG. 2, block 210. Beginning in block 400, for a specific order to be analyzed, the engine is invoked and parameters such as an exploded list of part numbers and required quantities of each are obtained from normal ERP functions. Additionally, parts stocking locations, on-hand inventory and Inventory Management Rules 300 of FIG. 3A are passed through the function. In block 410, CTB analysis for the order in question is executed against the inventory on hand in the highest priority location, as defined by Inventory Management Rules 300.

For each part number, the quantity required is compared against the quantity on hand in the highest priority location to determine coverage for the order. In block 420, if parts are available for coverage against the required amount, the logistics system incorporating the Inventory Management Rules, 300, will soft allocate the available inventory for each specific part in the current stocking location so that no other order will compete with it.

In block 430, once the available amount of parts are soft allocated, the original required amounts can be decremented to reflected updated amounts needed to be searched. Next in decision block 440, if it is determined that there still exists amounts that need to be searched and if, in decision block 460 it is determined that there are additional stocking locations to search, then the engine can be recursively invoked to begin a new function call to find the next highest priority location for the remaining quantity needed. If in decision block 460, it is determined that there are no other stocking locations to search per the Inventory Management Rules 300, then decision block 470 can be implemented to determine whether the order shall be built short.

If, in block 440 it is determined that no additional searches are required as all part requirements have been found across the previously searched locations, then in block 450 all the previous soft allocations can be transformed to hard reservations, the recursive function is ended and block 220 of FIG. 2 can be initiated. Similarly, if in block 470 it is determined that a build short is required, then in block 450 all previous soft allocations can be transformed to hard reservations and the recursive function is ended and block 220 of FIG. 2 can be initiated. If a build short is not required, then in block 480 all soft allocations are removed from Inventory Management Rules 300 which will free up inventory to be used on other competing orders and an error can be returned and an error message notification can be posted indicating that the order cannot be built due to parts shortages. Consequently, the order can be put back into the order queue for future processing. Finally, the process can end in block 490.

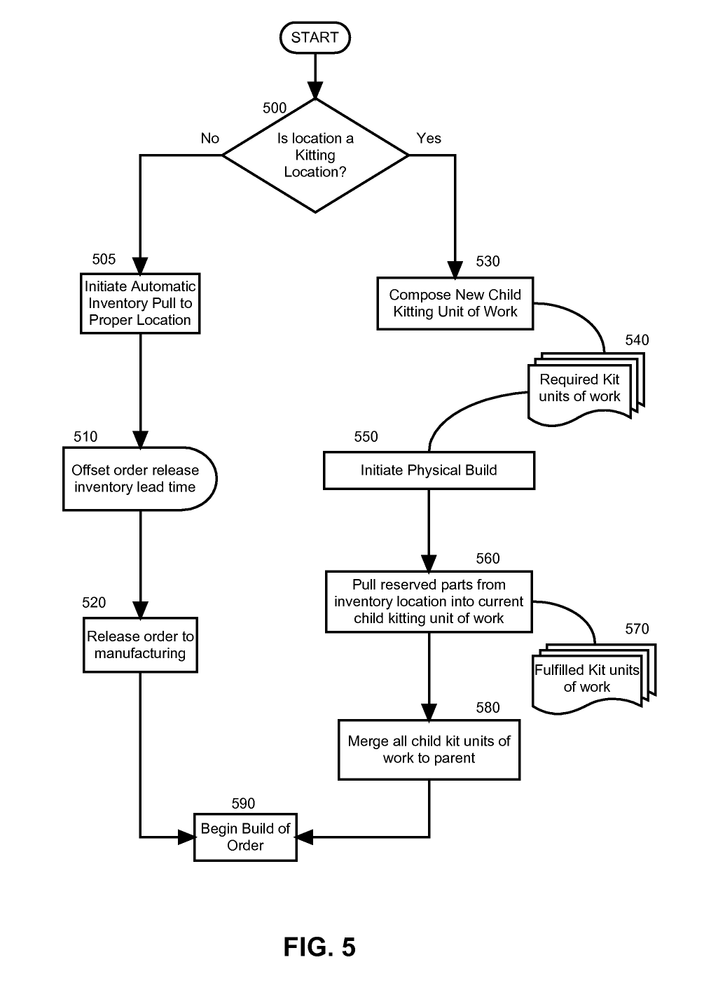

FIG. 5 is a flowchart illustrating a process for aggregate kitting and inventory movements handled in the process of FIG. 2, block 220. In decision block 500, if the stocking location being analyzed is not a kitting location then block 505 is implemented by initiating an automatic inventory pull to the proper stocking location. In block 510, there can be a time delay based on FIG. 3C that determines the highest offset for a given part in an order and adjusts the lead time to allow enough time to pull parts from one stocking location to an assembly area.

The maximum offset time can be allotted for the order. For example referring back to FIG. 3, block 330, if it takes 3 hours offset for part B to be pulled from PrimLocB to PrimLocA, and it takes 2 hours offset to pull parts from PrimLoca A to AssemLoc2, then the delay in block 510 will take into account the maximum time which in this example is 3 hours and ensure that all the parts are pulled within that period of time. Next in block 520 the order can be released to manufacturing successfully. Finally in block 590 manufacturing can begin build of the order.

In decision block 500, if the stocking location being analyzed is a kitting location then block 530 is implemented by creating a new child kitting unit of work that can represent the components that make up a kit. It is possible for a product to require multiple kits and thus it is possible to merge multiple child kitting units of work into a main parent unit of work which can be defined as the overall product that is ordered to be built. In block 540 a list of required parts for each kit unit of work is logically created to determine which parts are needed for each child kitting unit of work.

Once the parts lists for each child kitting unit of work are logically determined then in block 550 the physical kit build for the child work units can be initiated. Next in block 560, the reserved parts are physically pulled from an inventory stocking location and consumed into the current child kitting units of work. In block 570, the reserved parts are logically put into each child kitting unit of work by fulfilling the initial required parts list in block 540. Finally, in block 580, every child kit unit of work is aggregated to merge into a parent product. In block 590 the process ends with building of order.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. An order processing method comprising:
determining a required allocation of parts necessary to build an order;
recursively soft allocating parts in different locations until enough parts have been soft allocated to satisfy the required allocation of parts necessary to build the order; and,
hard allocating the soft allocated parts.

2. The method of claim 1, wherein prioritizing each of the stocking locations, comprises:
retrieving a part number for a part required to fulfill the order and a priority location list corresponding to the part number; and,
associating a priority with each of the stocking locations from which different parts are to be allocated to satisfy an order.

3. The method of claim 1, wherein recursively soft allocating parts in different locations until enough parts have been soft allocated to satisfy the required allocation of parts necessary to build the order, comprises:
retrieving a list of stocking locations for the parts;
prioritizing each of the stocking locations;
locating a highest priority one of the stocking locations having allocable ones of the parts and soft allocating the allocable parts;
removing the highest priority one of the stocking locations from the list and reducing the required allocation of parts by a number of soft allocated allocable parts in the highest priority one of the stocking locations; and,
repeating each of the retrieving, prioritizing, locating, removing and reducing for the list and required allocations of parts until the required allocation of parts is satisfied by the number of soft allocated allocable parts.

4. The method of claim 1, further comprising:
determining that not enough parts remain amongst the different locations to satisfy the required allocation of parts necessary to build the order; and,
clearing the soft allocated parts for allocation by a different order.

5. The method of claim 1, further comprising:
determining that not enough parts remain amongst the different locations to satisfy the required allocation of parts necessary to build the order; and,
building short the order by hard allocating the soft allocated parts even though not enough parts are soft allocated to satisfy the required allocation of parts.

6. The method of claim 1, further comprising kitting the parts when found in multiple stocking locations.

7. The method of claim 6, wherein kitting the parts when found in multiple stocking locations, comprises:
creating a new kitting child unit of work tied to a parent unit; and,
consolidating the child unit of work with the parent upon arrival of the child unit of work.

8. An inventory management data processing system comprising:
a data store of parts and stocking locations storing the parts; and,
a multiple location auto-cascading clear to build engine coupled to the data store, the engine comprising program code enabled to determine a required allocation of parts necessary to build an order, to recursively soft allocate parts in different locations specified by the data store until enough parts have been soft allocated to satisfy the required allocation of parts necessary to build the order, and to hard allocate the soft allocated parts.

9. A computer program product comprising a computer usable medium embodying computer usable program code for order processing, the computer program product comprising:
computer usable program code for determining a required allocation of parts necessary to build an order;
computer usable program code for recursively soft allocating parts in different locations until enough parts have been soft allocated to satisfy the required allocation of parts necessary to build the order; and,
computer usable program code for hard allocating the soft allocated parts.

10. The computer program product of claim 9, wherein the computer usable program code for prioritizing each of the stocking locations, comprises:
computer usable program code for retrieving a part number for a part required to fulfill the order and a priority location list corresponding to the part number; and,
associating a priority with each of the stocking locations from which different ones of the part are to be allocated to satisfy an order.

11. The computer program product of claim 9, wherein the computer usable program code for recursively soft allocating parts in different locations until enough parts have been soft allocated to satisfy the required allocation of parts necessary to build the order, comprises:
computer usable program code for retrieving a list of stocking locations for the parts;
computer usable program code for prioritizing each of the stocking locations;
computer usable program code for locating a highest priority one of the stocking locations having allocable ones of the parts and soft allocating the allocable parts;
computer usable program code for removing the highest priority one of the stocking locations from the list and reducing the required allocation of parts by a number of soft allocated allocable parts in the highest priority one of the stocking locations; and,
computer usable program code for repeating each of the retrieving, prioritizing, locating, removing and reducing for the list and required allocations of parts until the required allocation of parts is satisfied by the number of soft allocated allocable parts.

12. The computer program product of claim 9, further comprising:
computer usable program code for determining that not enough parts remain amongst the different locations to satisfy the required allocation of parts necessary to build the order; and,
computer usable program code for clearing the soft allocated parts for allocation by a different order.

13. The computer program product of claim 9, further comprising:
computer usable program code for determining that not enough parts remain amongst the different locations to satisfy the required allocation of parts necessary to build the order; and,
computer usable program code for building short the order by hard allocating the soft allocated parts even though not enough parts are soft allocated to satisfy the required allocation of parts.

14. The computer program product of claim 9, further comprising computer usable program code for kitting the parts when found in multiple stocking locations

15. The computer program product of claim 14, wherein the computer usable program code for kitting the parts when found in multiple stocking locations, comprises:
computer usable program code for creating a new kitting child unit of work tied to a parent unit; and,
computer usable program code for consolidating the child unit of work with the parent upon arrival of the child unit of work.
